(19) United States
(12) Patent Application Publication
(10) Pub. No.: US 2020/0159716 A1
(43) Pub. Date: May 21, 2020

(54) HIERARCHICAL DATA FILTER APPARATUS AND METHODS

(71) Applicant: General Electric Company, Schenectady, NY (US)

(72) Inventor: Keith Bates, Pittsburgh, PA (US)

(21) Appl. No.: 16/196,980

(22) Filed: Nov. 20, 2018

(51) Int. Cl. G06F 16/23; G06F 16/22

(52) U.S. Cl. CPC G06F 16/2365; G06F 16/2246

(57) ABSTRACT

Systems, methods, and apparatus providing hierarchical data filtering are disclosed and described. An example system includes a hierarchical data filter including a plurality of levels including at least a parent level and a child level, wherein a parent filter is to apply to the parent level and the child level and a child filter is to apply to the child level. An example processor is to execute the instructions to at least: analyze data to match a type of the data to a level in the plurality of levels of the hierarchical data filter; apply one or more filters from the hierarchical data filter to the data to filter the data according to the corresponding level of the data from the hierarchical data filter; and output filtered data from the applying of the one or more filters to the data.

### FIELD OF DISCLOSURE

The present disclosure relates to data processing, and more particularly to systems, methods and computer program products to filter data using a hierarchical data filter.

### BACKGROUND

The statements in this section merely provide background information related to the disclosure and may not constitute prior art.

Healthcare environments, such as hospitals or clinics, include information systems, such as hospital information systems (HIS), radiology information systems (RIS), clinical information systems (CIS), and cardiovascular information systems (CVIS), and storage systems, such as picture archiving and communication systems (PACS), library information systems (LIS), and electronic medical records (EMR). Information stored can include patient medication orders, medical histories, imaging data, test results, diagnosis information, management information, and/or scheduling information, for example. A wealth of information is available, but the information can be siloed in various separate systems requiring separate access, search, and retrieval. Correlations between healthcare data remain elusive due to technological limitations on the associated systems.

Further, when data is brought together for display, the amount of data can be overwhelming and confusing. Such data overload presents difficulties when trying to display, and competing priorities put a premium in available screen real estate. Existing solutions are deficient in addressing these and other related concerns.

### BRIEF DESCRIPTION

Certain examples provide a hierarchical data filtering system including a memory and a processor. The example memory is to store instructions and a data structure defining a hierarchical data filter. The example hierarchical data filter is to include a plurality of levels including at least a parent level and a child level, wherein a parent filter is to apply to the parent level and the child level and a child filter is to apply to the child level. The example processor is to execute the instructions to at least: analyze data to match a type of the data to a level in the plurality of levels of the hierarchical data filter; apply one or more filters from the hierarchical data filter to the data to filter the data according to the corresponding level of the data from the hierarchical data filter; and output filtered data from the applying of the one or more filters to the data. The example processor is to arbitrate a conflict between a first filter and a second filter to apply one of the first filter and the second filter to the data.

Certain examples provide a computer-readable storage medium including a data structure defining a hierarchical data filter. The example hierarchical data filter is to include a plurality of levels including at least a parent level and a child level, wherein a parent filter is to apply to the parent level and the child level and a child filter is to apply to the child level. The example computer-readable storage medium also includes instructions which, when executed, cause at least one processor to at least: analyze data to match a type of the data to a level in the plurality of levels of the hierarchical data filter; apply one or more filters from the hierarchical data filter to the data to filter the data according to the corresponding level of the data from the hierarchical data filter; and output filtered data from the applying of the one or more filters to the data. The example processor is to arbitrate a conflict between a first filter and a second filter to apply one of the first filter and the second filter to the data.

Certain examples provide a computer-implemented method including: analyzing, by executing an instruction with a processor with respect to a data structure defining a hierarchical data filter, data to match a type of the data to a level in a plurality of levels of the hierarchical data filter, the hierarchical data filter to include the plurality of levels including at least a parent level and a child level, wherein a parent filter is to apply to the parent level and the child level and a child filter is to apply to the child level. The example method includes applying one or more filters from the hierarchical data filter to the data to filter the data according to the corresponding level of the data from the hierarchical data filter. The example method includes outputting filtered data from the applying of the one or more filters to the data. In the example method, applying the one or more filters includes arbitrating, when present, a conflict between a first filter and a second filter to apply one of the first filter and the second filter to the data.

### BRIEF DESCRIPTION OF THE DRAWINGS

The features and technical aspects of the system and method disclosed herein will become apparent in the following Detailed Description in conjunction with the drawings in which reference numerals indicate identical or functionally similar elements.

FIG. 1 shows an example hierarchical data filter data structure.

FIG. 2 illustrates an example interface including a hierarchical data filter.

FIG. 3 shows a block diagram of an example healthcare-focused information system.

FIG. 4 shows a block diagram of an example healthcare information infrastructure including one or more systems.

FIG. 5 shows an example industrial internet configuration including a plurality of health-focused systems.

FIG. 6 shows an example imaging desktop system.

FIG. 7 illustrates an example hierarchical data filtering system.

FIGS. 8-9 illustrate flow diagrams for example method of user interface management.

FIG. 10 shows a block diagram of an example processor system that can be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings. The figures are not scale. Wherever possible, the same reference numbers will be used throughout the drawings and accompanying written description to refer to the same or like parts.

### DETAILED DESCRIPTION

In the following detailed description, reference is made to the accompanying drawings that form a part hereof, and in which is shown by way of illustration specific examples that may be practiced. These examples are described in sufficient detail to enable one skilled in the art to practice the subject matter, and it is to be understood that other examples may be utilized and that logical, mechanical, electrical and other changes may be made without departing from the scope of the subject matter of this disclosure. The following detailed description is, therefore, provided to describe an exemplary implementation and not to be taken as limiting on the scope of the subject matter described in this disclosure. Certain features from different aspects of the following description may be combined to form yet new aspects of the subject matter discussed below.

When introducing elements of various embodiments of the present disclosure, the articles “a,” “an,” and “the” are intended to mean that there are one or more of the elements. The terms “first,” “second,” and the like, do not denote any order, quantity, or importance, but rather are used to distinguish one element from another. The terms “comprising,” “including,” and “having” are intended to be inclusive and mean that there may be additional elements other than the listed elements. As the terms “connected to,” “coupled to,” etc. are used herein, one object (e.g., a material, element, structure, member, etc.) can be connected to or coupled to another object regardless of whether the one object is directly connected or coupled to the other object or whether there are one or more intervening objects between the one object and the other object.

As used herein, the terms “system,” “unit,” “module,” “engine,” etc., may include a hardware and/or software system that operates to perform one or more functions. For example, a module, unit, or system may include a computer processor, controller, and/or other logic-based device that performs operations based on instructions stored on a tangible and non-transitory computer readable storage medium, such as a computer memory. Alternatively, a module, unit, engine, or system may include a hard-wired device that performs operations based on hard-wired logic of the device. Various modules, units, engines, and/or systems shown in the attached figures may represent the hardware that operates based on software or hardwired instructions, the software that directs hardware to perform the operations, or a combination thereof.

In addition, it should be understood that references to “one embodiment” or “an embodiment” of the present disclosure are not intended to be interpreted as excluding the existence of additional embodiments that also incorporate the recited features.

### Overview

Aspects disclosed and described herein provide improved filter systems and associated methods including decision-making logic and hierarchical data structures to apply filters of varying granularity according to priority rules. For example, a hierarchical data filter can be set, and children of that data filter are set to the same value. However, if the data filter has no children, then only that filter is set to that value. In certain examples, child filters can have additional settings beyond the value set by the parent filter, and child filter settings can be shown in a user interface as well as the parent filter settings.

In certain examples, a filter mechanism also prioritizes filters based on an order in which the filters are applied. For example, a last (e.g., most recent) filter applied is given priority over earlier filters. Thus, if a global date filter and individual calendar filters are to be applied to a data set, such as a global date filter of 7 days and a clinical category filter of 30 days, the 30-day clinical filter overrides the 7-day global filter in the clinical category, while the global 30-day filter applies to other available categories of data. In some such examples, the user interface indicates where multiple filters have been applied. While date filters are used here as an example, other filters such as a body part filter, a modality filter, etc., can be applied.

Certain examples provide hierarchical data filters to enable a healthcare (e.g., radiology, other clinician, etc.) desktop facilitating a healthcare workflow. An example healthcare desktop provides an interaction framework in which a worklist is integrated with a diagnostic space and can be manipulated into and out of the diagnostic space to progress from a daily worklist to a particular diagnosis/diagnostic view for a patient (and back to the daily worklist). The worklist infrastructure shows the clinician what is to be done and on what task(s) the he or she is current working. Data preference and relevancy can be determined with respect to a radiology workflow and/or radiology desktop application interface, for example.

In certain examples, the healthcare desktop provides a diagnostic hub and facilitates a dynamic workflow and adaptive composition of a graphical user interface. For example, the desktop graphical user interface provides an intelligently adaptive, dynamically adjustable interface based on information, not just user clicks, as well as dynamic real time updates from a server. The healthcare desktop provides a higher level framework built with multiple roles in mind (e.g., not only radiology but other -ologies as well to unify workflows and provide an expandable and reusable framework). Additionally, areas of the healthcare desktop interact such that an action on one client and triggers notification of another client regarding state change(s) corresponding to the action.

In an example, one side (e.g., a left hand side) of the healthcare desktop interface is configurable by the user. The user can select a worklist on the left side of the desktop graphical user interface (GUI), and the worklist appears (e.g., “pops out” or is otherwise displayed) on the side of the healthcare desktop GUI. The worklist and/or set of displayed information can be configured in a plurality of ways including via a segmented or tiered display area including a worklist, a subset of the worklist, and a workspace work area for document display and interaction, for example.

Aspects disclosed and described herein enable information aggregation and information filtering that cannot be accomplished in a current clinical workflow. Certain examples provide new hierarchical data filter data structures, priority-driven multi-filter processing, and user interface functionality to display hierarchical data filtering results and facilitate interaction.

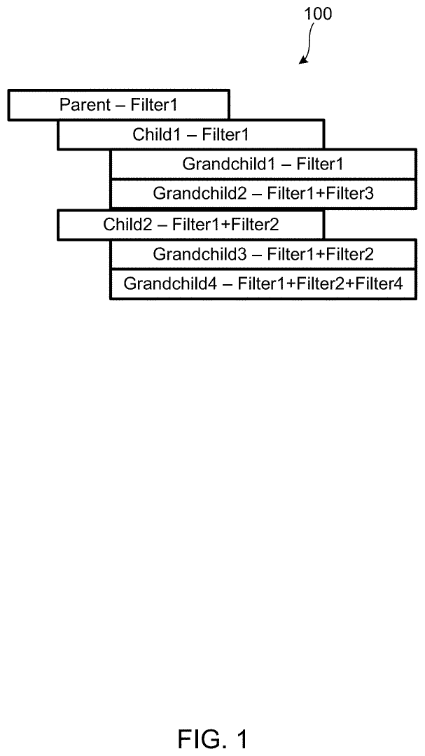

For example, FIG. 1 illustrates an example hierarchical data filter data structure 100. The example data structure 100 includes a parent filter, Filter1, which applies to the parent, children, and grandchildren in the example data structure 100. One branch of the data structure 100, Child2, includes an additional child filter, Filter2, which applies to its grandchildren as well as parent Filter1. In addition, further grandchildren of Child1 and Child2 apply further filters, Filter3 and Filter4, respectively, to filter data.

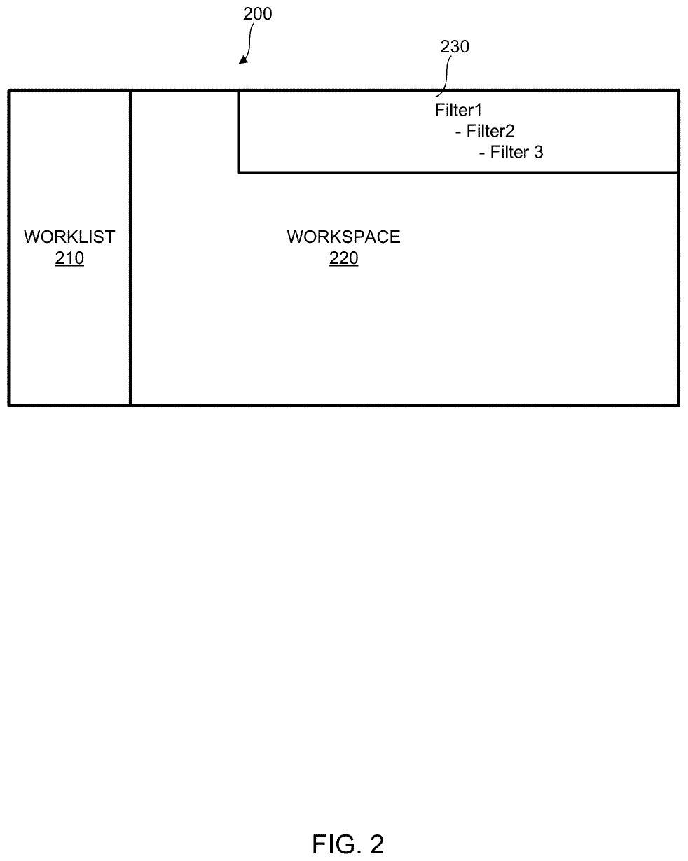

FIG. 2 illustrates an example interface 200 applying one or more hierarchical data filters 100 to data from one or more sources, such as data incoming from exam records for review, data to be processed for relevancy and provided for clinical decision support, etc. The example interface 200 includes a worklist 210 of items corresponding to records for display in a workspace 220. One or more filters 230, such as the hierarchical data filter 100, can be selected, configured, and/or otherwise applied 230 to content in the workspace 220, items in the worklist 210, incoming data from one or more data sources, etc.

Other aspects, such as those discussed in the following and others as can be appreciated by one having ordinary skill in the art upon reading the enclosed description, are also possible.

### II. Example Operating Environment

Health information, also referred to as healthcare information and/or healthcare data, relates to information generated and/or used by a healthcare entity. Health information can be information associated with health of one or more patients, for example. Health information can include protected health information (PHI), as outlined in the Health Insurance Portability and Accountability Act (HIPAA), which is identifiable as associated with a particular patient and is protected from unauthorized disclosure. Health information can be organized as internal information and external information. Internal information includes patient encounter information (e.g., patient-specific data, aggregate data, comparative data, etc.) and general healthcare operations information, etc. External information includes comparative data, expert and/or knowledge-based data, etc. Information can have both a clinical (e.g., diagnosis, treatment, prevention, etc.) and administrative (e.g., scheduling, billing, management, etc.) purpose.

Institutions, such as healthcare institutions, having complex network support environments and sometimes chaotically driven process flows utilize secure handling and safeguarding of the flow of sensitive information (e.g., personal privacy). A need for secure handling and safeguarding of information increases as a demand for flexibility, volume, and speed of exchange of such information grows. For example, healthcare institutions provide enhanced control and safeguarding of the exchange and storage of sensitive patient PHI and employee information between diverse locations to improve hospital operational efficiency in an operational environment typically having a chaotic-driven demand by patients for hospital services. In certain examples, patient identifying information can be masked or even stripped from certain data depending upon where the data is stored and who has access to that data. In some examples, PHI that has been “de-identified” can be re-identified based on a key and/or other encoder/decoder.

A healthcare information technology infrastructure can be adapted to service multiple business interests while providing clinical information and services. Such an infrastructure can include a centralized capability including, for example, a data repository, reporting, discreet data exchange/connectivity, “smart” algorithms, personalization/consumer decision support, etc. This centralized capability provides information and functionality to a plurality of users including medical devices, electronic records, access portals, pay for performance (P4P), chronic disease models, and clinical health information exchange/regional health information organization (HIE/RHIO), and/or enterprise pharmaceutical studies, home health, for example.

Interconnection of multiple data sources helps enable an engagement of all relevant members of a patient's care team and helps improve an administrative and management burden on the patient for managing his or her care. Particularly, interconnecting the patient's electronic medical record and/or other medical data can help improve patient care and management of patient information. Furthermore, patient care compliance is facilitated by providing tools that automatically adapt to the specific and changing health conditions of the patient and provide comprehensive education and compliance tools to drive positive health outcomes.

In certain examples, healthcare information can be distributed among multiple applications using a variety of database and storage technologies and data formats. To provide a common interface and access to data residing across these applications, a connectivity framework (CF) can be provided which leverages common data and service models (CDM and CSM) and service oriented technologies, such as an enterprise service bus (ESB) to provide access to the data.

In certain examples, a variety of user interface frameworks and technologies can be used to build applications for health information systems including, but not limited to, MICROSOFT® ASP.NET, AJAX®, MICROSOFT® Windows Presentation Foundation, GOOGLE® Web Toolkit, MICROSOFT® Silverlight, ADOBE®, and others. Applications can be composed from libraries of information widgets to display multi-content and multi-media information, for example. In addition, the framework enables users to tailor layout of applications and interact with underlying data.

In certain examples, an advanced Service-Oriented Architecture (SOA) with a modern technology stack helps provide robust interoperability, reliability, and performance. The example SOA includes a three-fold interoperability strategy including a central repository (e.g., a central repository built from Health Level Seven (HL7) transactions), services for working in federated environments, and visual integration with third-party applications. Certain examples provide portable content enabling plug 'n play content exchange among healthcare organizations. A standardized vocabulary using common standards (e.g., LOINC, SNOMED CT, RxNorm, FDB, ICD-9, ICD-10, etc.) is used for interoperability, for example. Certain examples provide an intuitive user interface to help minimize end-user training. Certain examples facilitate user-initiated launching of third-party applications directly from a desktop interface to help provide a seamless workflow by sharing user, patient, and/or other contexts. Certain examples provide real-time (or at least substantially real time assuming some system delay) patient data from one or more information technology (IT) systems and facilitate comparison(s) against evidence-based best practices. Certain examples provide one or more dashboards for specific sets of patients. Dashboard(s) can be based on condition, role, and/or other criteria to indicate variation(s) from a desired practice, for example.

### a. Example Healthcare Information System

An information system can be defined as an arrangement of information/data, processes, and information technology that interact to collect, process, store, and provide informational output to support delivery of healthcare to one or more patients. Information technology includes computer technology (e.g., hardware and software) along with data and telecommunications technology (e.g., data, image, and/or voice network, etc.).

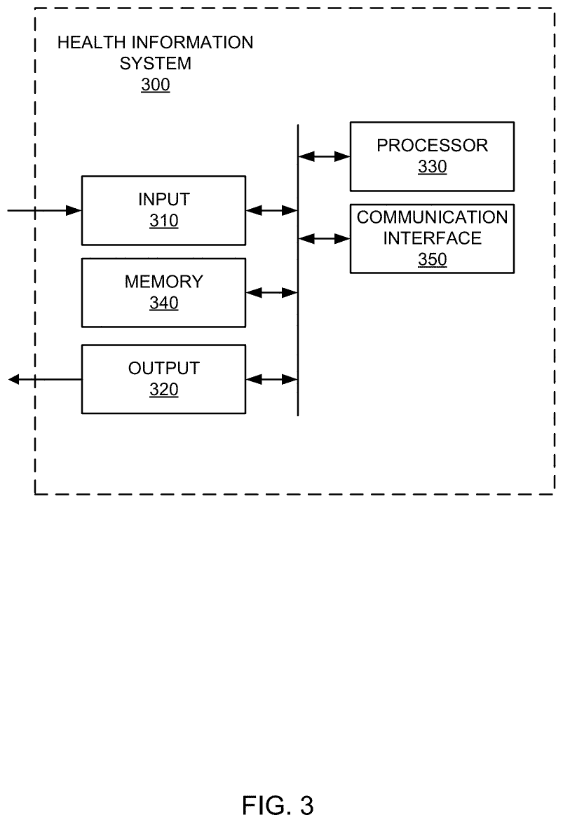

Turning now to the figures, FIG. 3 shows a block diagram of an example healthcare-focused information system 300. The example system 300 can be configured to implement a variety of systems and processes including image storage (e.g., picture archiving and communication system (PACS), etc.), image processing and/or analysis, radiology reporting and/or review (e.g., radiology information system (RIS), etc.), computerized provider order entry (CPOE) system, clinical decision support, patient monitoring, population health management (e.g., population health management system (PHMS), health information exchange (HIE), etc.), healthcare data analytics, cloud-based image sharing, electronic medical record (e.g., electronic medical record system (EMR), electronic health record system (EHR), electronic patient record (EPR), personal health record system (PHR), etc.), and/or other health information system (e.g., clinical information system (CIS), hospital information system (HIS), patient data management system (PDMS), laboratory information system (LIS), cardiovascular information system (CVIS), etc.

As illustrated in FIG. 3, the example information system 300 includes an input 310, an output 320, a processor 330, a memory 340, and a communication interface 350. The components of the example system 300 can be integrated in one device or distributed over two or more devices.

The example input 310 can include a keyboard, a touch-screen, a mouse, a trackball, a track pad, optical barcode recognition, voice command, etc. or combination thereof used to communicate an instruction or data to the system 300. The example input 310 can include an interface between systems, between user(s) and the system 300, etc.

The example output 320 can provide a display generated by the processor 330 for visual illustration on a monitor or the like. The display can be in the form of a network interface or graphic user interface (GUI) to exchange data, instructions, or illustrations on a computing device via the communication interface 350, for example. The example output 320 can include a monitor (e.g., liquid crystal display (LCD), plasma display, cathode ray tube (CRT), etc.), light emitting diodes (LEDs), a touch-screen, a printer, a speaker, or other conventional display device or combination thereof

The example processor 330 includes hardware and/or software configuring the hardware to execute one or more tasks and/or implement a particular system configuration. The example processor 330 processes data received at the input 310 and generates a result that can be provided to one or more of the output 320, memory 340, and communication interface 350. For example, the example processor 330 can take user annotation provided via the input 310 with respect to an image displayed via the output 320 and can generate a report associated with the image based on the annotation. For example, the output 220 can include the user interface 200. As another example, the processor 330 can process updated patient information obtained via the input 310 to provide an updated patient record to an EMR via the communication interface 350.

The example memory 340 can include a relational database, an object-oriented database, a data dictionary, a clinical data repository, a data warehouse, a data mart, a vendor neutral archive, an enterprise archive, etc. The example memory 340 stores images, patient data, best practices, clinical knowledge, analytics, reports, etc. The example memory 340 can store data and/or instructions for access by the processor 330. In certain examples, the memory 340 can be accessible by an external system via the communication interface 350.

In certain examples, the memory 340 stores and controls access to encrypted information, such as patient records, encrypted update-transactions for patient medical records, including usage history, etc. In an example, medical records can be stored without using logic structures specific to medical records. In such a manner the memory 340 is not searchable. For example, a patient's data can be encrypted with a unique patient-owned key at the source of the data. The data is then uploaded to the memory 340. The memory 340 does not process or store unencrypted data thus minimizing privacy concerns. The patient's data can be downloaded and decrypted locally with the encryption key.

For example, the memory 340 can be structured according to provider, patient, patient/provider association, and document. Provider information can include, for example, an identifier, a name, and address, a public key, and one or more security categories. Patient information can include, for example, an identifier, a password hash, and an encrypted email address. Patient/provider association information can include a provider identifier, a patient identifier, an encrypted key, and one or more override security categories. Document information can include an identifier, a patient identifier, a clinic identifier, a security category, and encrypted data, for example. Patient records can include a flag stored in a data structure in the memory 340 to indicate whether or not that record is pinned in the pinned area 110, for example.

The example communication interface 350 facilitates transmission of electronic data within and/or among one or more systems. Communication via the communication interface 350 can be implemented using one or more protocols. In some examples, communication via the communication interface 350 occurs according to one or more standards (e.g., Digital Imaging and Communications in Medicine (DICOM), Health Level Seven (HL7), ANSI X12N, etc.). The example communication interface 350 can be a wired interface (e.g., a data bus, a Universal Serial Bus (USB) connection, etc.) and/or a wireless interface (e.g., radio frequency, infrared, near field communication (NFC), etc.). For example, the communication interface 350 can communicate via wired local area network (LAN), wireless LAN, wide area network (WAN), etc. using any past, present, or future communication protocol (e.g., BLUETOOTH™, USB 2.0, USB 3.0, etc.).

In certain examples, a Web-based portal may be used to facilitate access to information, patient care and/or practice management, etc. Information and/or functionality available via the Web-based portal may include one or more of order entry, laboratory test results review system, patient information, clinical decision support, medication management, scheduling, electronic mail and/or messaging, medical resources, etc. In certain examples, a browser-based interface can serve as a zero footprint, zero download, and/or other universal viewer for a client device.

In certain examples, the Web-based portal serves as a central interface to access information and applications, for example. Data may be viewed through the Web-based portal or viewer, for example. Additionally, data may be manipulated and propagated using the Web-based portal, for example. Data may be generated, modified, stored and/or used and then communicated to another application or system to be modified, stored and/or used, for example, via the Web-based portal, for example.

The Web-based portal may be accessible locally (e.g., in an office) and/or remotely (e.g., via the Internet and/or other private network or connection), for example. The Web-based portal may be configured to help or guide a user in accessing data and/or functions to facilitate patient care and practice management, for example. In certain examples, the Web-based portal may be configured according to certain rules, preferences and/or functions, for example. For example, a user may customize the Web portal according to particular desires, preferences and/or requirements.

### b. Example Healthcare Infrastructure

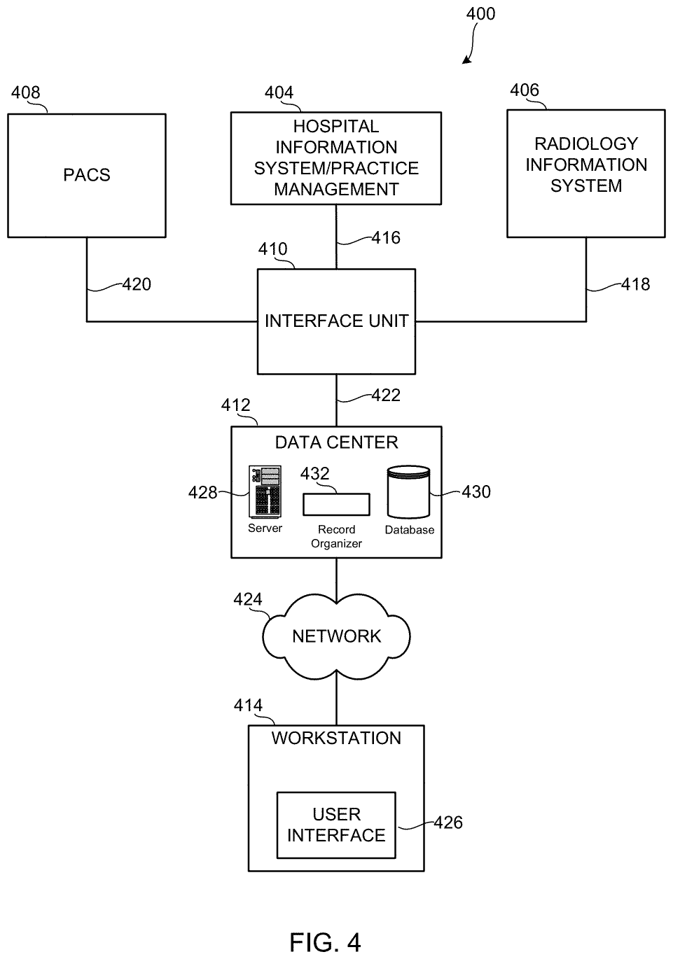

FIG. 4 shows a block diagram of an example healthcare information infrastructure 400 including one or more subsystems such as the example healthcare-related information system 300 illustrated in FIG. 3. The example healthcare system 400 includes a HIS 404, a RIS 406, a PACS 408, an interface unit 410, a data center 412, and a workstation 414. In the illustrated example, the HIS 404, the RIS 406, and the PACS 408 are housed in a healthcare facility and locally archived. However, in other implementations, the HIS 404, the MS 406, and/or the PACS 408 can be housed one or more other suitable locations. In certain implementations, one or more of the PACS 408, MS 406, HIS 404, etc., can be implemented remotely via a thin client and/or downloadable software solution. Furthermore, one or more components of the healthcare system 400 can be combined and/or implemented together. For example, the MS 406 and/or the PACS 408 can be integrated with the HIS 404; the PACS 408 can be integrated with the MS 406; and/or the three example information systems 404, 406, and/or 408 can be integrated together. In other example implementations, the healthcare system 400 includes a subset of the illustrated information systems 404, 406, and/or 408. For example, the healthcare system 400 can include only one or two of the HIS 404, the MS 406, and/or the PACS 408. Information (e.g., scheduling, test results, exam image data, observations, diagnosis, etc.) can be entered into the HIS 404, the MS 406, and/or the PACS 408 by healthcare practitioners (e.g., radiologists, physicians, and/or technicians) and/or administrators before and/or after patient examination.

The HIS 404 stores medical information such as clinical reports, patient information, and/or administrative information received from, for example, personnel at a hospital, clinic, and/or a physician's office (e.g., an EMR, EHR, PHR, etc.). The RIS 406 stores information such as, for example, radiology reports, radiology exam image data, messages, warnings, alerts, patient scheduling information, patient demographic data, patient tracking information, and/or physician and patient status monitors. Additionally, the RIS 406 enables exam order entry (e.g., ordering an x-ray of a patient) and image and film tracking (e.g., tracking identities of one or more people that have checked out a film). In some examples, information in the RIS 406 is formatted according to the HL-7 (Health Level Seven) clinical communication protocol. In certain examples, a medical exam distributor is located in the RIS 406 to facilitate distribution of radiology exams to a radiologist workload for review and management of the exam distribution by, for example, an administrator.

The PACS 408 stores medical images (e.g., x-rays, scans, three-dimensional renderings, etc.) as, for example, digital images in a database or registry. In some examples, the medical images are stored in the PACS 408 using the Digital Imaging and Communications in Medicine (DICOM) format. Images are stored in the PACS 408 by healthcare practitioners (e.g., imaging technicians, physicians, radiologists) after a medical imaging of a patient and/or are automatically transmitted from medical imaging devices to the PACS 408 for storage. In some examples, the PACS 408 can also include a display device and/or viewing workstation to enable a healthcare practitioner or provider to communicate with the PACS 408.

The interface unit 410 includes a hospital information system interface connection 416, a radiology information system interface connection 418, a PACS interface connection 420, and a data center interface connection 422. The interface unit 410 facilities communication among the HIS 404, the RIS 406, the PACS 408, and/or the data center 412. The interface connections 416, 418, 420, and 422 can be implemented by, for example, a Wide Area Network (WAN) such as a private network or the Internet. Accordingly, the interface unit 410 includes one or more communication components such as, for example, an Ethernet device, an asynchronous transfer mode (ATM) device, an 802.11 device, a DSL modem, a cable modem, a cellular modem, etc. In turn, the data center 412 communicates with the workstation 414, via a network 424, implemented at a plurality of locations (e.g., a hospital, clinic, doctor's office, other medical office, or terminal, etc.). The network 424 is implemented by, for example, the Internet, an intranet, a private network, a wired or wireless Local Area Network, and/or a wired or wireless Wide Area Network. In some examples, the interface unit 410 also includes a broker (e.g., a Mitra Imaging's PACS Broker) to allow medical information and medical images to be transmitted together and stored together.

The interface unit 410 receives images, medical reports, administrative information, exam workload distribution information, and/or other clinical information from the information systems 404, 406, 408 via the interface connections 416, 418, 420. If necessary (e.g., when different formats of the received information are incompatible), the interface unit 410 translates or reformats (e.g., into Structured Query Language (“SQL”) or standard text) the medical information, such as medical reports, to be properly stored at the data center 412. The reformatted medical information can be transmitted using a transmission protocol to enable different medical information to share common identification elements, such as a patient name or social security number. Next, the interface unit 410 transmits the medical information to the data center 412 via the data center interface connection 422. Finally, medical information is stored in the data center 412 in, for example, the DICOM format, which enables medical images and corresponding medical information to be transmitted and stored together.

The medical information is later viewable and easily retrievable at the workstation 414 (e.g., by their common identification element, such as a patient name or record number). The workstation 414 can be any equipment (e.g., a personal computer) capable of executing software that permits electronic data (e.g., medical reports) and/or electronic medical images (e.g., x-rays, ultrasounds, MRI scans, etc.) to be acquired, stored, or transmitted for viewing and operation. The workstation 414 receives commands and/or other input from a user via, for example, a keyboard, mouse, track ball, microphone, etc. The workstation 414 is capable of implementing a user interface 426 to enable a healthcare practitioner and/or administrator to interact with the healthcare system 400. For example, in response to a request from a physician, the user interface 426 presents a patient medical history. In other examples, a radiologist is able to retrieve and manage a workload of exams (e.g., the worklist area 120) distributed for review to the radiologist via the user interface 426. For example, the user interface 426 can form the interface 200. In further examples, an administrator reviews radiologist workloads, exam allocation, and/or operational statistics associated with the distribution of exams via the user interface 426. In some examples, the administrator adjusts one or more settings or outcomes via the user interface 426.

The example data center 412 of FIG. 4 is an archive to store information such as images, data, medical reports, and/or, more generally, patient medical records. In addition, the data center 412 can also serve as a central conduit to information located at other sources such as, for example, local archives, hospital information systems/radiology information systems (e.g., the HIS 404 and/or the RIS 406), or medical imaging/storage systems (e.g., the PACS 408 and/or connected imaging modalities). That is, the data center 412 can store links or indicators (e.g., identification numbers, patient names, or record numbers) to information. In the illustrated example, the data center 412 is managed by an application server provider (ASP) and is located in a centralized location that can be accessed by a plurality of systems and facilities (e.g., hospitals, clinics, doctor's offices, other medical offices, and/or terminals). In some examples, the data center 412 can be spatially distant from the HIS 404, the RIS 406, and/or the PACS 408 (e.g., at GENERAL ELECTRIC® headquarters).

The example data center 412 of FIG. 4 includes a server 428, a database 430, and a record organizer 432. The server 428 receives, processes, and conveys information to and from the components of the healthcare system 400. The database 430 stores the medical information described herein and provides access thereto. The example record organizer 432 of FIG. 4 manages patient medical histories, for example. The record organizer 432 can also assist in procedure scheduling, for example.

Certain examples can be implemented as cloud-based clinical information systems and associated methods of use. An example cloud-based clinical information system enables healthcare entities (e.g., patients, clinicians, sites, groups, communities, and/or other entities) to share information via web-based applications, cloud storage and cloud services. For example, the cloud-based clinical information system may enable a first clinician to securely upload information into the cloud-based clinical information system to allow a second clinician to view and/or download the information via a web application. Thus, for example, the first clinician may upload an x-ray image into the cloud-based clinical information system, and the second clinician may view the x-ray image via a web browser and/or download the x-ray image onto a local information system employed by the second clinician.

In certain examples, users (e.g., a patient and/or care provider) can access functionality provided by the system 400 via a software-as-a-service (SaaS) implementation over a cloud or other computer network, for example. In certain examples, all or part of the system 400 can also be provided via platform as a service (PaaS), infrastructure as a service (IaaS), etc. For example, the system 400 can be implemented as a cloud-delivered Mobile Computing Integration Platform as a Service. A set of consumer-facing Web-based, mobile, and/or other applications enable users to interact with the PaaS, for example.

### c. Industrial Internet Examples

The Internet of things (also referred to as the “Industrial Internet”) relates to an interconnection between a device that can use an Internet connection to talk with other devices on the network. Using the connection, devices can communicate to trigger events/actions (e.g., changing temperature, turning on/off, provide a status, etc.). In certain examples, machines can be merged with “big data” to improve efficiency and operations, provide improved data mining, facilitate better operation, etc.

Big data can refer to a collection of data so large and complex that it becomes difficult to process using traditional data processing tools/methods. Challenges associated with a large data set include data capture, sorting, storage, search, transfer, analysis, and visualization. A trend toward larger data sets is due at least in part to additional information derivable from analysis of a single large set of data, rather than analysis of a plurality of separate, smaller data sets. By analyzing a single large data set, correlations can be found in the data, and data quality can be evaluated.

FIG. 4 illustrates an example industrial internet configuration 500. The example configuration 400 includes a plurality of health-focused systems 510-512, such as a plurality of health information systems 300 (e.g., PACS, RIS, EMR, etc.) communicating via the industrial internet infrastructure 500. The example industrial internet 500 includes a plurality of health-related information systems 510-512 communicating via a cloud 520 with a server 530 and associated data store 540.

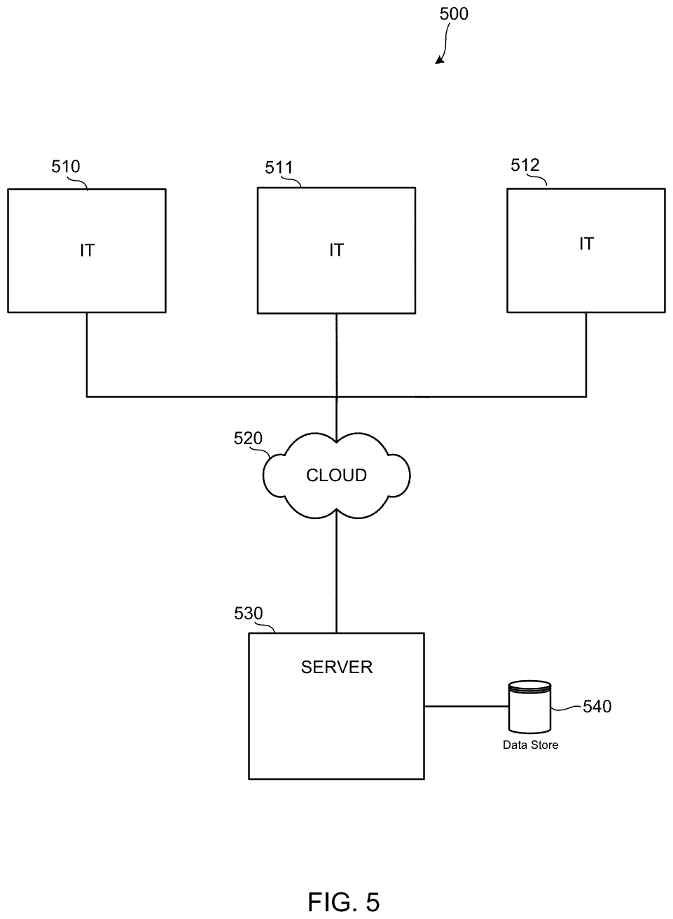

As shown in the example of FIG. 5, a plurality of devices (e.g., information systems, imaging modalities, etc.) 510-512 can access a cloud 520, which connects the devices 510-512 with a server 530 and associated data store 540. Information systems, for example, include communication interfaces to exchange information with server 530 and data store 540 via the cloud 520. Other devices, such as medical imaging scanners, patient monitors, etc., can be outfitted with sensors and communication interfaces to enable them to communicate with each other and with the server 530 via the cloud 520.

Thus, machines 510-512 in the system 500 become “intelligent” as a network with advanced sensors, controls, and software applications. Using such an infrastructure, advanced analytics can be provided to associated data. The analytics combines physics-based analytics, predictive algorithms, automation, and deep domain expertise. Via the cloud 520, devices 510-512 and associated people can be connected to support more intelligent design, operations, maintenance, and higher server quality and safety, for example.

Using the industrial internet infrastructure, for example, a proprietary machine data stream can be extracted from a device 510. Machine-based algorithms and data analysis are applied to the extracted data. Data visualization can be remote, centralized, etc. Data is then shared with authorized users, and any gathered and/or gleaned intelligence is fed back into the machines 510-512.

### d. Imaging Workstation Examples

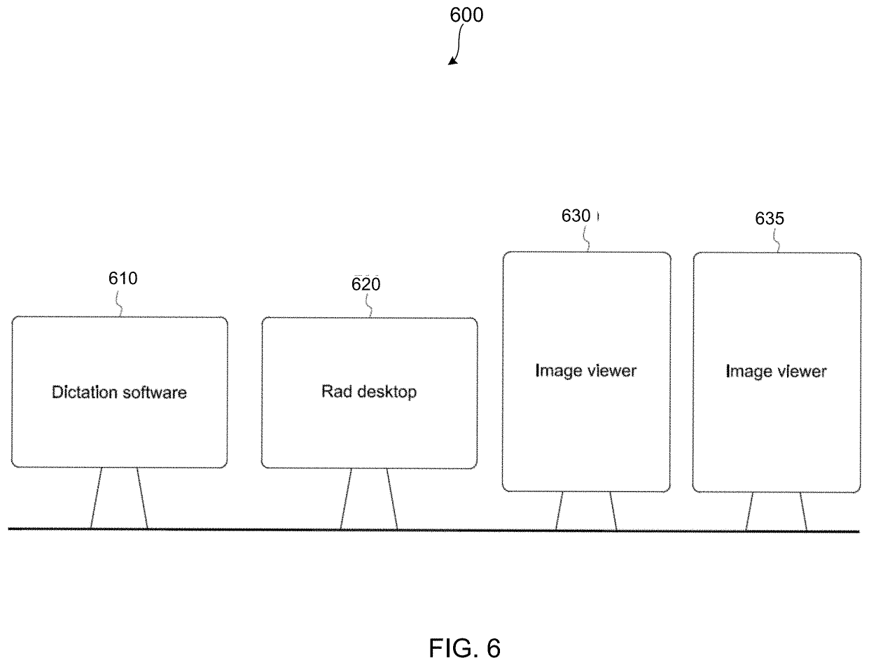

FIG. 6 illustrates an example imaging desktop system including an image/exam viewer implemented on a plurality of diagnostic monitors 630, 635. A dictation application 610 either sits side-by-side with a radiology desktop or workflow manager 620, on a same monitor as the radiology desktop/workflow manager 620, or behind/in front of the radiology desktop/workflow manager 620 such that a user toggles between two windows 610, 620. In other examples, image viewing, image analysis, and/or dictation can be combined on a single workstation. Thus, the multiple displays 610-635 can be combined into a single interface (e.g., the example interface 200, 426) having a plurality of windows or areas for information display and interaction.

A radiologist, for example, can be presented with summary information, trending, and extracted features made available so that the radiology does not have to search through a patient's prior radiology report history. The radiologist receives decision support including relevant clinical and diagnostic information to assist in a more definitive, efficient diagnosis.

In certain examples, a hierarchical data filter can be applied to records on a worklist for one or more patients X, Y, Z to form a subset of records to be prefetched from a data source. For example, if a current study for patient X is being processed, prior report(s) for patient X are located (e.g., from a picture archiving and communication system (PACS), enterprise archive (EA), radiology information system (RIS), electronic medical record (EMR), etc.). For example, report text and prior study metadata including a reason for exam, exam code, study, name, location, etc., can be used to filter results provided from the one or more data sources for mining, extraction, and processing via a workspace.

In certain examples, a workload manager resides on a side (e.g., a left-hand side, a right-hand side, top, bottom, etc.) of a radiology desktop and can be opened or otherwise accessed to access exams. The workload manager and/or an associated diagnostic hub can leverage the information identification, retrieval, and relevancy determination systems and methods disclosed and described herein to provide information for research, comparison, supplementation, guidance, etc., in conjunction with an exam under review (e.g., via an exam preview panel from a patient library, etc.).

For example, the diagnostic hub can include a patient banner. The patient banner displays patient demographic data as well as other patient information that is persistent and true regardless of the specific exam (e.g., age, medical record number (MRN), cumulative radiation dose, etc.). The diagnostic hub also includes a primary exam preview panel. The primary exam preview panel provides a summary of the exam that the radiologist is currently responsible for reading (e.g., the exam that was selected from an active worklist). Exam description and reason for exam can be displayed to identify the exam, followed by metadata such as exam time, location, referrer, technologist, etc.

A patient library is devoted to helping a radiologist focus on relevant comparison exams, as well as any additional clinical content to aid in diagnosis. The patient library of the diagnostic hub can include subsections such as a clinical journey, comparison list, a comparison exam preview panel, etc. The clinical journey is a full patient ‘timeline’ of imaging exams, as well as other clinical data such as surgical and pathology reports, labs, medications, etc. The longitudinal view of the clinical journey helps the radiologist notice broader clinical patterns more quickly, as well as understand a patient's broader context that may not be immediately evident in a provided reason for the primary exam. Tools can be provided to navigate within the clinical journey. A user can adjust a time frame, filter for specific criteria, turn relevancy on or off, add or remove content categories, etc. The clinical journey also integrates with the comparison list. Modifying filter or search criteria in the clinical journey can impact the exams displayed on the comparison list.

The comparison list provides one or more available comparison exams for the current patient/primary exam. The comparison list provides a quick access point for selecting comparisons, as opposed to the more longitudinal clinical journey. Display can be limited to only show relevant exams based on the relevancy algorithm, for example. The comparison exam preview panel is similar to the primary exam preview panel, with alterations in content display to account for a radiologist's shift in priorities when looking at a comparison (e.g., selected from the comparison list, etc.). Rather than providing a reason for exam, a history and impression from the exam's report are displayed (or the whole report, if extraction is not possible or desired, etc.).

### e. Data Mining Examples

Imaging informatics includes determining how to tag and index a large amount of data acquired in diagnostic imaging in a logical, structured, and machine-readable format. By structuring data logically, information can be discovered and utilized by algorithms that represent clinical pathways and decision support systems. For example, exam records can be indexed and/or otherwise filtered based on one or more filters such as the hierarchical data filter structure 100. Data mining can be used to help ensure patient safety, reduce disparity in treatment, provide clinical decision support, etc. Mining both structured and unstructured data from radiology reports, as well as actual image pixel data, can be used to tag and index both imaging reports and the associated images themselves.

### f. Example Clinical Workflows

Clinical workflows are typically defined to include one or more steps, elements, and/or actions to be taken in response to one or more events and/or according to a schedule. Events may include receiving a healthcare message associated with one or more aspects of a clinical record, opening a record(s) for new patient(s), receiving a transferred patient, reviewing and reporting on an image, and/or any other instance and/or situation that requires or dictates responsive action or processing. The actions, elements, and/or steps of a clinical workflow may include placing an order for one or more clinical tests, scheduling a procedure, requesting certain information to supplement a received healthcare record, retrieving additional information associated with a patient, providing instructions to a patient and/or a healthcare practitioner associated with the treatment of the patient, radiology image reading, and/or any other action useful in processing healthcare information. The defined clinical workflows can include manual actions, elements, and/or steps to be taken by, for example, an administrator or practitioner, electronic actions, elements, and/or steps to be taken by a system or device, and/or a combination of manual and electronic action(s), element(s), and/or step(s). While one entity of a healthcare enterprise may define a clinical workflow for a certain event in a first manner, a second entity of the healthcare enterprise may define a clinical workflow of that event in a second, different manner. In other words, different healthcare entities may treat or respond to the same event or circumstance in different fashions. Differences in workflow approaches may arise from varying preferences, capabilities, requirements or obligations, standards, protocols, etc. among the different healthcare entities.

In certain examples, a medical exam conducted on a patient can involve review by a healthcare practitioner, such as a radiologist, to obtain, for example, diagnostic information from the exam. In a hospital setting, medical exams can be ordered for a plurality of patients, all of which require review by an examining practitioner. Each exam has associated attributes, such as a modality, a part of the human body under exam, and/or an exam priority level related to a patient criticality level. Hospital administrators, in managing distribution of exams for review by practitioners, can consider the exam attributes as well as staff availability, staff credentials, and/or institutional factors such as service level agreements and/or overhead costs.

Additional workflows can be facilitated such as bill processing, revenue cycle mgmt., population health management, patient identity, consent management, etc.

For example, a radiology department in a hospital, clinic, or other healthcare facility facilitates a sequence of events for patient care of a plurality of patients. At registration and scheduling, a variety of information is gathered such as patient demographic, insurance information, etc. The patient can be registered for a radiology procedure, and the procedure can be scheduled on an imaging modality.

Before the patient arrives for the scheduled procedures, pre-imaging activities can be coordinated. For example, the patient can be advised on pre-procedure dietary restrictions, etc. Upon arrive, the patient is checked-in, and patient information is verified. Identification, such as a patient identification tag, etc., is issued.

Then, the patient is prepared for imaging. For example, a nurse or technologist can explain the imaging procedure, etc. For contrast media imaging, the patient is prepared with contrast media etc. The patient is guided through the imaging procedure, and image quality is verified. Using an image viewer and reporting tools, the radiologist reads the resulting image(s), performs dictation in association with the images, and approves associated reports. For example, the radiologist activates the interface 200, selects the patient's exam from the worklist area 210 to open the exam record in the workspace 220 and read and report on the exam. One or more filters (e.g., the hierarchical data filter structure 100, etc.) can be applied to reduce content shown to the user, for example. A billing specialist can prepare a claim for each completed procedure, and claims can be submitted to an insurer.

### III. Example Hierarchical Data Filter Apparatus

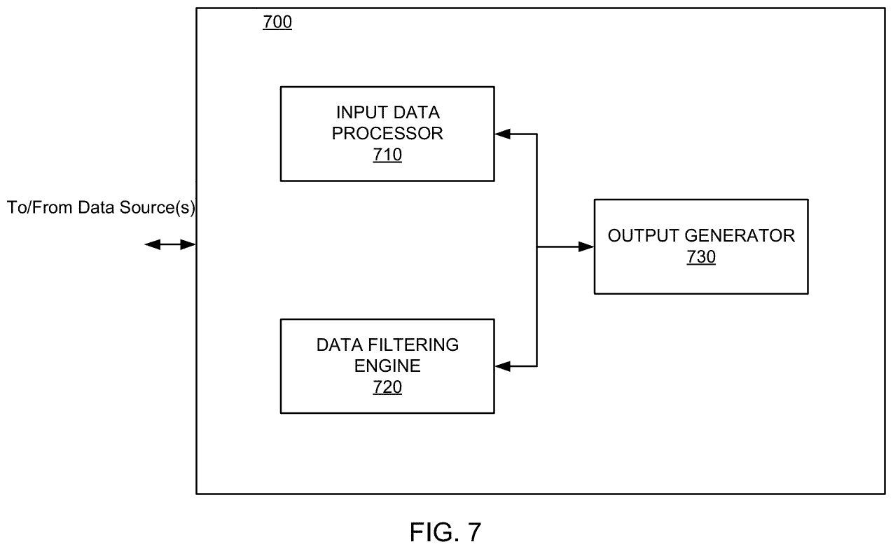

FIG. 7 illustrates an example hierarchical data filtering system 700 including an input data processor 710, a data filtering engine 720, and an output generator 730. The example input data processor 710 receives input, such as exam records, imaging studies, patient data, etc., from one or more data sources such as a PACS, RIS, EMR, enterprise archive (EA), vendor neutral archive (VNA), cloud-based storage, etc. Thus, for example, the input data processor 710 retrieves and/or receives incoming records such as exam records, other patient records, etc., and processes those records for display and interaction via the example interface 200.

The example data filtering engine 720 applies one or more filters, such as the hierarchical data filter defined in the example data structure 100, to the input data from the input data processor 710. Thus, a large pipeline of data can be gathered in the system 700 by the input data processor 710, and the data filtering engine 720 reduces the data to a relevant subset of available data through the filter 100.

The example output generator 730 can process available data, such as relevant data resulting from application of the hierarchical data filter 100 by the filtering engine 720, to generate an output such as a user interface display (e.g., user interface 200, 426, etc.), data feed to another application, data output for storage in a data store, computer-aided diagnosis, exam reading, etc.

In operation, for example, the data filtering engine 720 can apply the hierarchical data filter 100 to a set of incoming exam records that are related. Leveraging the hierarchical relationship of parent to child to grandchild, which indicates that the parent is the base data structure and each child and grandchild provides a further specific variant from the base parent, one or more filters can be applied to the related set of exam records. The parent filter is applied to all of the related records, and child and/or grandchild filters can apply to certain subsets. In certain examples, if multiple filters of the same type are applied to the same branch/node/level of the hierarchy, a most recently applied filter is applied. Hierarchy, however, controls, with child nodes being bound by a parent filter, although a child may have a separate, additional filter (e.g., the parent filter filters exam records by date and a child filter filters exam records by body part, modality, etc.). A total set of filter(s) applied to a given exam record or set of exam records can be displayed via the user interface 200, 426 to allow a user to see, select, and/or modify filter(s) applied to the data, for example.

### IV. Example Hierarchical Data Filtering Methods

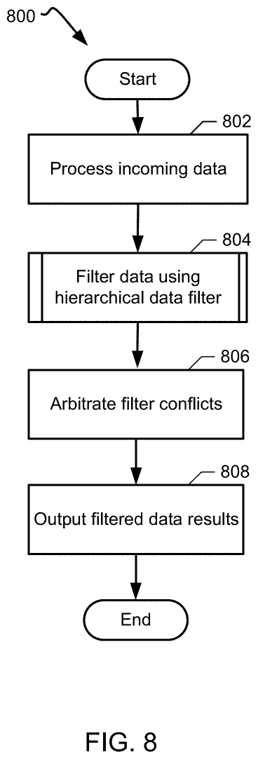

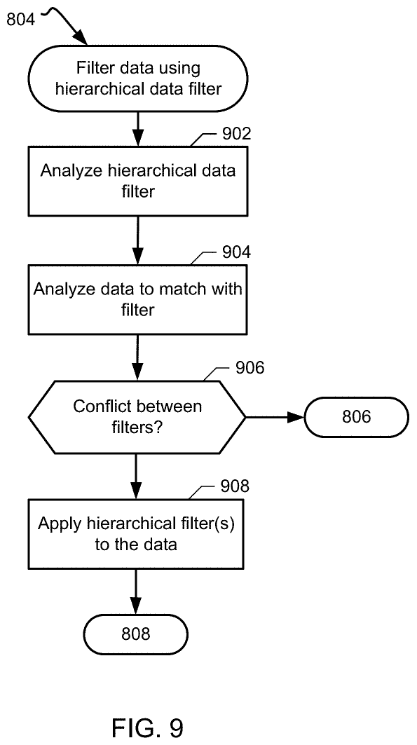

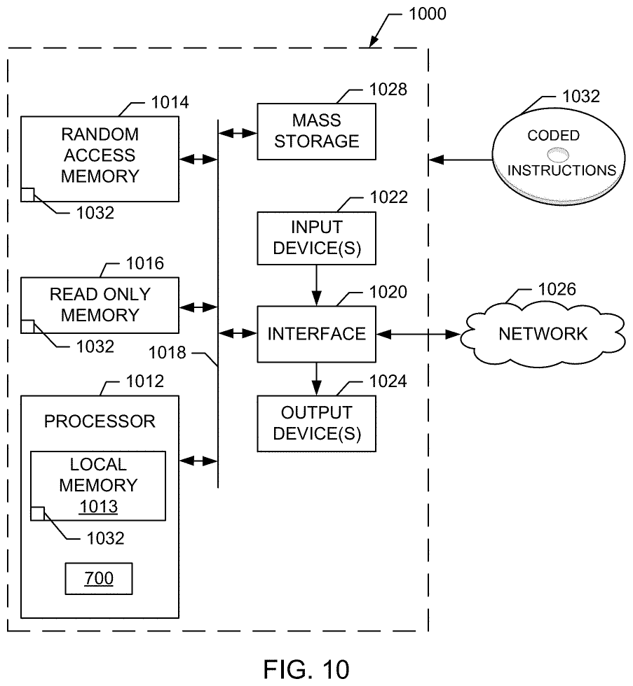

Flowcharts representative of example machine readable instructions for implementing and/or executing in conjunction with the example systems, algorithms, and interfaces of FIGS. 1-7 are shown in FIGS. 8-9. In these examples, the machine readable instructions comprise a program for execution by a processor such as the processor 1012 shown in the example processor platform 1300 discussed below in connection with FIG. 10. The program can be embodied in software stored on a tangible computer readable storage medium such as a CD-ROM, a floppy disk, a hard drive, a digital versatile disk (DVD), a BLU-RAY™ disk, or a memory associated with the processor 1012, but the entire program and/or parts thereof could alternatively be executed by a device other than the processor 1012 and/or embodied in firmware or dedicated hardware. Further, although the example program is described with reference to the flowcharts and/or processes illustrated in FIGS. 8-9, many other methods of implementing the examples disclosed and described here can alternatively be used. For example, the order of execution of the blocks can be changed, and/or some of the blocks described can be changed, eliminated, or combined.

As mentioned above, the example processes of FIG. 8-9 can be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIGS. 8-9 can be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 8 illustrates a flow diagram for an example method 800 to configure and apply a hierarchical data filter 100 to one or more data records. At block 802, incoming data is processed. For example, records such as exam records, imaging studies, other patient records, etc., are processed from one or more data sources such as a PACS, EMR, RIS, EA, VNA, etc., to prepare the data for use.

At block 804, the data is filtered using a hierarchical data filter 100. For example, a hierarchical electronic medical record data filter is applied to incoming data from an EMR. A top-level filter regarding dates is applied to the entire set of EMR data. In this example, the hierarchical filter also includes a body part filter for a clinical category of EMR data, and, therefore, clinical data from the set of EMR data is also filtered using the body part filter as well as the global date filter. Other categories aside from clinical can include scheduling, historical, social, etc., and each category can have particular rules or just rely on global EMR filtering rule(s), for example.

At block 806, conflicts between filters are arbitrated. For example, if two filters prescribe two different date periods (e.g., one week versus one month, etc.), then the more recently defined filter controls. For example, if the first defined filter specified one month but a later filter instead specified one week, then the later-added one week filter would control in this example. In another example, a global filter controls over a specific child filter. In another example, however, a specified child (or grandchild, etc.) rule that contradicts a parent/global rule controls. Thus, conflicting rule determination can depend on the particular installation or configuration of the system (e.g., to specify whether the parent/global rule is always right and preempts conflicting changes at lower levels versus specifying that particular rules for particular child/grandchild instances are to be followed over general parent rules, etc.).

In certain examples, new filters can be provided/updated over time to the data structure 100. If the new filter is a global/parent filter, then all filters in the data structure 100 can be overridden by the new global filter. If the new filter is an individual filter specific to a certain level of the hierarchy, however, then the new filter only overrides the applicable individual filter(s) with the new filter, for example.

At block 808, filtered data results are output. For example, EMR data remaining after application of the hierarchical data filter 100 can be displayed in a workspace for review and interaction, can be added to a record, can be tagged and saved, can be provided to another program or system for computer-aided diagnosis, can be used in image analysis, etc. Thus, hierarchical data filtering provides nuanced, level-specific filtering of voluminous, complex data according to particular resolution rules to provide relevant content to users, systems, applications, etc.

FIG. 9 illustrates a flow diagram providing further detail regarding an example implementation of filtering data using the hierarchical data filter 100 (block 804). At block 902, the hierarchical data filter 100 is analyzed by the data filtering engine 720 to determine levels of hierarchy included in the data structure 100 and rule(s) associated with each level of the hierarchy. For example, the data filtering engine 720 analyzes the data structure for the hierarchical data filter 100 and identifies a parent filter, Filter1; two children, Child1 and Child2, with Child2 having an additional filter, Filter2; 4 grandchildren, Grandchild1-Grandchild4, with Grandchild2 and Grandchild4 having further filters, Filter3 and Filter4, respectively.

At block 904, data incoming though the input data processor 710 is analyzed to match the data with the hierarchy of the hierarchical data filter 100. For example, incoming exam records from a PACS are analyzed to identify which type(s) of records (e.g., image study records, lab results, physician examination notes, etc.) are present in the set of exam records. Global rules for patient exam records may apply to all records, while a particular modality filter (e.g., only x-ray, only ultrasound, etc.) may apply to the image study records, only a certain range or threshold may apply to the lab results, only a particular condition may apply to the physician exam notes, etc.). Thus, data can be matched with applicable filter(s) from the hierarchy 100.

At block 906, if a conflict exists between rules in the hierarchical data filter 100, then control reverts to block 806 to arbitrate the conflict. Otherwise, at block 908, the hierarchical data filter 100 is applied to the data. Control then reverts to output results of the filtering at block 808, for example.

### V. Computing Device

The subject matter of this description may be implemented as stand-alone system or for execution as an application capable of execution by one or more computing devices. The application (e.g., webpage, downloadable applet or other mobile executable) can generate the various displays or graphic/visual representations described herein as graphic user interfaces (GUIs) or other visual illustrations, which may be generated as webpages or the like, in a manner to facilitate interfacing (receiving input/instructions, generating graphic illustrations) with users via the computing device(s).

Memory and processor as referred to herein can be stand-alone or integrally constructed as part of various programmable devices, including for example a desktop computer or laptop computer hard-drive, field-programmable gate arrays (FPGAs), application-specific integrated circuits (ASICs), application-specific standard products (ASSPs), system-on-a-chip systems (SOCs), programmable logic devices (PLDs), etc. or the like or as part of a Computing Device, and any combination thereof operable to execute the instructions associated with implementing the method of the subject matter described herein.

Computing device as referenced herein can include: a mobile telephone; a computer such as a desktop or laptop type; a Personal Digital Assistant (PDA) or mobile phone; a notebook, tablet or other mobile computing device; or the like and any combination thereof

Computer readable storage medium or computer program product as referenced herein is tangible (and alternatively as non-transitory, defined above) and can include volatile and non-volatile, removable and non-removable media for storage of electronic-formatted information such as computer readable program instructions or modules of instructions, data, etc. that may be stand-alone or as part of a computing device. Examples of computer readable storage medium or computer program products can include, but are not limited to, RAM, ROM, EEPROM, Flash memory, CD-ROM, DVD-ROM or other optical storage, magnetic cassettes, magnetic tape, magnetic disk storage or other magnetic storage devices, or any other medium which can be used to store the desired electronic format of information and which can be accessed by the processor or at least a portion of the computing device.

The terms module and component as referenced herein generally represent program code or instructions that causes specified tasks when executed on a processor. The program code can be stored in one or more computer readable mediums.

Network as referenced herein can include, but is not limited to, a wide area network (WAN); a local area network (LAN); the Internet; wired or wireless (e.g., optical, Bluetooth, radio frequency (RF)) network; a cloud-based computing infrastructure of computers, routers, servers, gateways, etc.; or any combination thereof associated therewith that allows the system or portion thereof to communicate with one or more computing devices.

The term user and/or the plural form of this term is used to generally refer to those persons capable of accessing, using, or benefiting from the present disclosure.

FIG. 10 is a block diagram of an example processor platform 1000 capable of executing instructions to implement the example systems and methods disclosed and described herein. The processor platform 1000 can be, for example, a server, a personal computer, a mobile device (e.g., a cell phone, a smart phone, a tablet such as an IPAD™) a personal digital assistant (PDA), an Internet appliance, or any other type of computing device.

The processor platform 1000 of the illustrated example includes a processor 1012. The processor 1012 of the illustrated example is hardware. For example, the processor 1012 can be implemented by one or more integrated circuits, logic circuits, microprocessors or controllers from any desired family or manufacturer.

The processor 1012 of the illustrated example includes a local memory 1013 (e.g., a cache). The processor 1012 of the illustrated example is in communication with a main memory including a volatile memory 1014 and a non-volatile memory 1016 via a bus 1018. The volatile memory 1014 can be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1016 can be implemented by flash memory and/or any other desired type of memory device. Access to the main memory 1014, 1016 is controlled by a memory controller.

The processor platform 1000 of the illustrated example also includes an interface circuit 1020. The interface circuit 1020 can be implemented by any type of interface standard, such as an Ethernet interface, a universal serial bus (USB), and/or a PCI express interface.

In the illustrated example, one or more input devices 1022 are connected to the interface circuit 1020. The input device(s) 1022 permit(s) a user to enter data and commands into the processor 1012. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 1024 are also connected to the interface circuit 1020 of the illustrated example. The output devices 1024 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 1020 of the illustrated example, thus, typically includes a graphics driver card, a graphics driver chip or a graphics driver processor.

The interface circuit 1020 of the illustrated example also includes a communication device such as a transmitter, a receiver, a transceiver, a modem and/or network interface card to facilitate exchange of data with external machines (e.g., computing devices of any kind) via a network 1026 (e.g., an Ethernet connection, a digital subscriber line (DSL), a telephone line, coaxial cable, a cellular telephone system, etc.).

The processor platform 1000 of the illustrated example also includes one or more mass storage devices 1028 for storing software and/or data. Examples of such mass storage devices 1028 include floppy disk drives, hard drive disks, compact disk drives, Blu-ray disk drives, RAID systems, and digital versatile disk (DVD) drives.

The coded instructions 1032 can be stored in the mass storage device 1028, in the volatile memory 1014, in the non-volatile memory 1016, and/or on a removable tangible computer readable storage medium such as a CD or DVD. The instructions 1032 can be executed by the processor 1012 to implement the example hierarchical data filtering system 700, etc., as disclosed and described above.

From the foregoing, it will be appreciated that example methods, apparatus and articles of manufacture have been disclosed that improve filtering of and interaction with data. The disclosed methods, apparatus and articles of manufacture improve the efficiency of using a computing device and an interface being driven by the computing device by providing a hierarchical data filter to selectively filter aspects of data in a large volume of data. Certain examples improve a computer system and its process and user interface display through the ability to apply global filters as well as selectively provide and/or update individual filters, a task enabled by a new hierarchical data filter data structure previously unavailable. While prior approaches did not provide such hierarchy in filtering and suffered from lack of granularity which results in loss of relevant data, computing performance issues, impact on patient safety, etc., certain examples alter the operation of the computing device and provide a new data structure to store hierarchical data filters and a new methodology to apply such filters to a stream of incoming data. The disclosed methods, apparatus and articles of manufacture are accordingly directed to one or more improvement(s) in the functioning of a computer, as well as a new data structure and method of filtering information (e.g., healthcare data, etc.).

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A hierarchical data filtering system comprising:
a memory to store instructions and a data structure defining a hierarchical data filter, the hierarchical data filter to include a plurality of levels including at least a parent level and a child level, wherein a parent filter is to apply to the parent level and the child level and a child filter is to apply to the child level;
a processor to execute the instructions to at least:
analyze data to match a type of the data to a level in the plurality of levels of the hierarchical data filter;
apply one or more filters from the hierarchical data filter to the data to filter the data according to the corresponding level of the data from the hierarchical data filter; and
output filtered data from the applying of the one or more filters to the data,
wherein the processor is to arbitrate a conflict between a first filter and a second filter to apply one of the first filter and the second filter to the data.

2. The system of claim 1, wherein the processor is to arbitrate the conflict between the first filter and the second filter to select one of the first filter and the second filter that was applied to the hierarchical data filter latest in time.

3. The system of claim 1, wherein the first filter is the parent filter and the second filter is the child filter, and wherein the processor is to arbitrate the conflict between the first filter and the second filter to apply the parent filter instead of the child filter.

4. The system of claim 1, wherein the first filter is the parent filter and the second filter is the child filter, and wherein the processor is to arbitrate the conflict between the first filter and the second filter to apply the child filter instead of the parent filter.

5. The system of claim 1, wherein the processor is to update the data structure of a hierarchical data filter with a third filter.

6. The system of claim 5, wherein first filter is the parent filter and the second filter is the child filer, wherein the third filter is to override the first filter and the second filter when the third filter is a parent filter, and wherein the third filter is to override the second filter when the third filter is a child filter.

7. The system of claim 1, wherein the processor is to generate a user interface to display the filtered data.

8. The system of claim 7, wherein the user interface is to display an indication of the one or more filters applied to generate the filtered data.

9. A computer-readable storage medium including a data structure defining a hierarchical data filter, the hierarchical data filter to include a plurality of levels including at least a parent level and a child level, wherein a parent filter is to apply to the parent level and the child level and a child filter is to apply to the child level, the computer-readable storage medium also including instructions which, when executed, cause at least one processor to at least:
analyze data to match a type of the data to a level in the plurality of levels of the hierarchical data filter;
apply one or more filters from the hierarchical data filter to the data to filter the data according to the corresponding level of the data from the hierarchical data filter; and
output filtered data from the applying of the one or more filters to the data,
wherein the processor is to arbitrate a conflict between a first filter and a second filter to apply one of the first filter and the second filter to the data.

10. The computer-readable storage medium of claim 9, wherein the instructions, when executed, cause the processor to arbitrate the conflict between the first filter and the second filter to select one of the first filter and the second filter that was applied to the hierarchical data filter latest in time.

11. The computer-readable storage medium of claim 9, wherein the first filter is the parent filter and the second filter is the child filter, and wherein the instructions, when executed, cause the processor to arbitrate the conflict between the first filter and the second filter to apply the parent filter instead of the child filter.

12. The computer-readable storage medium of claim 9, wherein the first filter is the parent filter and the second filter is the child filter, and wherein the instructions, when executed, cause the processor to arbitrate the conflict between the first filter and the second filter to apply the child filter instead of the parent filter.

13. The computer-readable storage medium of claim 1, wherein the instructions, when executed, cause the processor to update the data structure of a hierarchical data filter with a third filter.

14. The computer-readable storage medium of claim 13, wherein first filter is the parent filter and the second filter is the child filer, wherein the third filter is to override the first filter and the second filter when the third filter is a parent filter, and wherein the third filter is to override the second filter when the third filter is a child filter.

15. The computer-readable storage medium of claim 9, wherein the instructions, when executed, cause the processor to generate a user interface to display the filtered data.

16. The computer-readable storage medium of claim 15, wherein the user interface is to display an indication of the one or more filters applied to generate the filtered data.

17. A computer-implemented method comprising:
analyzing, by executing an instruction with a processor with respect to a data structure defining a hierarchical data filter, data to match a type of the data to a level in a plurality of levels of the hierarchical data filter, the hierarchical data filter to include the plurality of levels including at least a parent level and a child level, wherein a parent filter is to apply to the parent level and the child level and a child filter is to apply to the child level;
applying one or more filters from the hierarchical data filter to the data to filter the data according to the corresponding level of the data from the hierarchical data filter; and
outputting filtered data from the applying of the one or more filters to the data,
wherein applying the one or more filters includes arbitrating, when present, a conflict between a first filter and a second filter to apply one of the first filter and the second filter to the data.

18. The method of claim 17, wherein arbitrating the conflict between the first filter and the second filter includes selecting one of the first filter and the second filter that was applied to the hierarchical data filter latest in time.

19. The method of claim 17, further including updating the data structure of a hierarchical data filter with a third filter.

20. The method of claim 19, wherein first filter is the parent filter and the second filter is the child filer, wherein the third filter is to override the first filter and the second filter when the third filter is a parent filter, and wherein the third filter is to override the second filter when the third filter is a child filter.
